(19) United States
(12) Patent Application Publication
(10) Pub. No.: US 2025/0199492 A1
(43) Pub. Date: Jun. 19, 2025

(54) Control Device

(71) Applicant: Saginomiya Seisakusho, Inc., Tokyo (JP)

(72) Inventor: Eiji NAKAJIMA, Saitama (JP)

(21) Appl. No.: 18/967,367

(22) Filed: Dec. 3, 2024

(30) Foreign Application Priority Data
Dec. 13, 2023 (JP) 2023-210127

(51) Int. Cl. G05B 15/02; G05B 6/02

(52) U.S. Cl. CPC G05B 15/02; G05B 6/02

(57) ABSTRACT

An information processing method includes calculating a target value of the physical quantity after the switching by using an inverse transfer function after the switching when switching the physical quantities used in the feedback control.

### CROSS-REFERENCE TO RELATED APPLICATION

This application claims the priority benefit of Japanese Patent Application No. 2021-091840 filed Dec. 13, 2023, which is fully incorporated herein by reference.

### TECHNICAL FIELD

The present disclosure relates to a control device.

### BACKGROUND ART

There is a control device capable of performing a feedback control with respect to a control object by various types of physical quantities. For example, in Patent Document 1, a control device having a control means for multiple systems in correspondence to various types of physical quantities respectively so as to be able to perform the feedback control with respect to the control object due to the various types of physical quantities.

### CITATION LIST

### Patent Documents

Patent Document 1: JP 5841795B

### SUMMARY OF THE INVENTION

### Technical Problem

When switching the physical quantities used in the feedback control, there is a case in which a discontinuous change occurs in the operation quantity input to the control object. It is possible that such discontinuous change in the operation quantity causes a shock (impact) to the control object. Thus, according to the control device disclosed in Patent Document 1, the operation quantities are memorized sequentially in advance, and at the time of switching the physical quantities used in the feedback control, by outputting the most recently memorized operation quantity among the memorized operation quantity to the control object, the discontinuous change in the operation quantity when switching the systems of the control means is prevented. However, according to the control device disclosed in Patent Document 1, the switching when the control object is stopped is regarded as a target, and the switching when the control object is in an operation is not regarded as the target.

An object of the present disclosure is to perform a feedback control to a control object by various types of physical quantities.

### Solution to Problem

In order to solve the above-identified problem, an information processing method according to an embodiment of the present invention is an information processing method executed by a computer for performing a feedback control to a control object by various types of physical quantities, wherein when switching the physical quantities used in the feedback control, calculating a target value of the physical quantity after the switching by using an inverse transfer function after the switching.

When switching the physical quantity used in the feedback control from a first physical quantity to a second physical quantity, it may calculate a target value of the second physical quantity based on both of an operation quantity in response to a difference between a target value of the first physical quantity and a control quantity, and a control quantity of the second physical quantity.

When switching the physical quantity used in the feedback control from the second physical quantity to the first physical quantity, it may calculate a target value of the first physical quantity based on both of an operation quantity in response to a difference between a target value of the second physical quantity and a control quantity, and a control quantity of the first physical quantity.

An information processing device according to an embodiment of the present invention is an information processing device calculating target values of various types of physical quantities for performing a feedback control to a control object by various types of physical quantities, wherein when switching the physical quantities used in the feedback control, the information processing device calculates a target value of the physical quantity after the switching by using an inverse transfer function after the switching.

When switching the physical quantity used in the feedback control from a first physical quantity to a second physical quantity, it may calculate a target value of the second physical quantity based on both of an operation quantity in response to a difference between a target value of the first physical quantity and a control quantity, and a control quantity of the second physical quantity.

When switching the physical quantity used in the feedback control from the second physical quantity to the first physical quantity, it may calculate a target value of the first physical quantity based on both of an operation quantity in response to a difference between a target value of the second physical quantity and a control quantity, and a control quantity of the first physical quantity.

A control device according to an embodiment of the present invention is a control device performing the feedback control to the control object, including the information processing device; a first control portion; a second control portion; and a switching portion, wherein the information processing device outputs the target value of the first physical quantity and the target value of the second physical quantity, the first control portion receives an input of the target value of the first physical quantity and the control quantity and outputs the operation quantity in response to the difference between the input target value of the first physical quantity and the control quantity, the second control portion receives an input of the target value of the second physical quantity and the control quantity and outputs the operation quantity in response to the difference between the input target value of the second physical quantity and the control quantity, and the switching portion switches between a first state to input the operation quantity output from the first control portion to the control object and a second state to input the operation quantity output from the second control portion to the control object, wherein it is the first state if the physical quantity used for the feedback control is the first physical quantity, and it is the second state if the physical quantity used for the feedback control is the second physical quantity.

### Effect of the Invention

According to the present disclosure, it is possible to perform the feedback control to the control object by various types of physical quantities.

### BRIEF DESCRIPTION OF THE DRAWINGS

FIG. 1 is a view showing a control device 100 according to an embodiment of the present invention.

FIG. 2 is a view describing a control of a control object 200 by the control device 100.

FIG. 3 is a view showing an example of a processing operation in the control device 100.

FIG. 4 is a view showing another example of the control device 100.

FIG. 5 is a view describing a control of a control object 200 by another example of the control device 100.

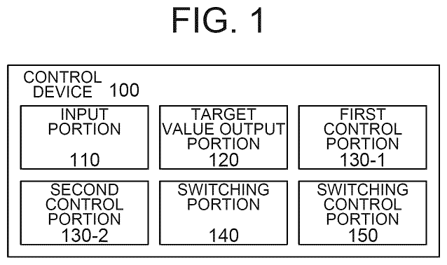

### DESCRIPTION OF EMBODIMENTS

<Control device 100> FIG. 1 is a view showing a control device 100 according to an embodiment of the present invention. The control device 100 includes an input portion 110, a target value output portion 120, a first control portion 130-1, a second control portion 130-2, a switching portion 140, and a switching control portion 150.

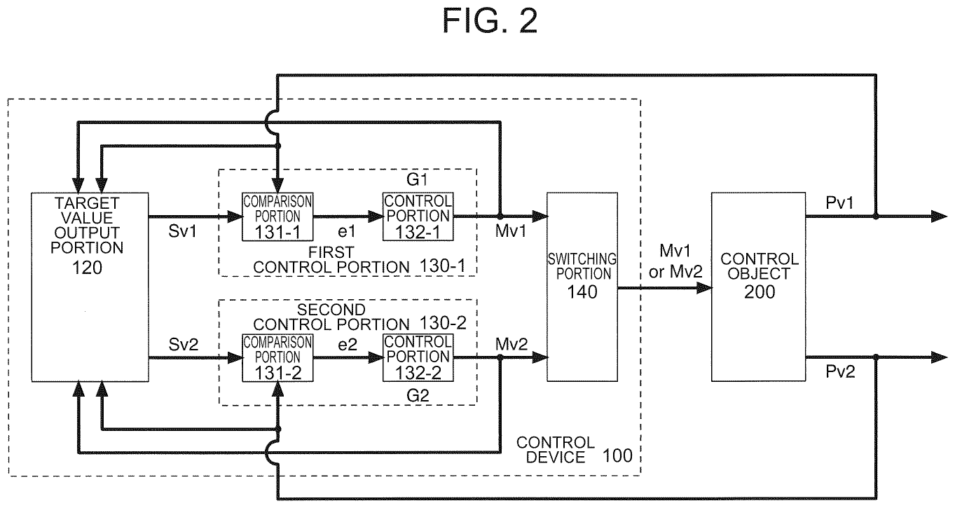

FIG. 2 is a view describing the control to a control object 200 by the control device 100. As shown in FIG. 2, in the control device 100, a control quantity of a first physical quantity Pv1(s) and a control quantity of a second physical quantity, being different from the first physical quantity, Pv2(s) are input. Then, as shown in FIG. 2, the control device 100 outputs a first operation quantity Mv1(s) based on the control quantity of a first physical quantity Pv1(s) and a second operation quantity Mv2(s) based on the control quantity of a second physical quantity Pv2(s) to the control object 200. That is, the control device 100 performs a feedback control with respect to the control object 200 due to the first physical quantity or the second physical quantity. The control quantity of a first physical quantity Pv1(s) and the control quantity of a second physical quantity Pv2(s) are measured by a senor, for example.

The control object, for example, is a vibrator (for example, a vibrator in a test device). In a case in which the control object 200 is a vibrator of a test device, for example, the first physical quantity is a displacement (for example, a displacement of a work by the vibrator), and the second physical quantity is a load (for example, a load applied to the work by the vibrator).

The input portion 110 is an input device for receiving an information input, such as a bottom, a keyboard, a touch panel, a microphone and the like. As described above, the control device 100 performs the feedback control with respect to the control object due to the first physical quantity or the second physical quantity. Thus, the control modes of the control device 100 includes a first mode of performing the feedback control with respect to the control object 200 due to the first physical quantity, and a second mode of performing the feedback control with respect to the control object 200 due to the second physical quantity. The input portion 110 receives the input of a switching instruction of the control modes of the control device 100.

The target value output portion 120 outputs a target value of first physical quantity Sv1(s) and a target value of second physical quantity Sv2(s). The target value of first physical quantity Sv1(s) output from the target value output portion 120 is input to the first control portion 130-1, and the target value of second physical quantity Sv2(s) output from the target value output portion 120 is input to the second control portion 130-2. The target value output portion 120 includes an information processing device such as a computer or the like, for example.

The first control portion 130-1 receives the input of the target value of first physical quantity Sv1(s) and the control quantity Pv1(s) to output the operation quantity Mv1(s) of the control object 200. As shown in FIG. 2, the first control portion 130-1 includes a comparison portion 131-1 and a control portion 132-1. The comparison portion 131-1 receives the input of the target value of first physical quantity Sv1(s) and the control quantity Pv1(s) to output a difference (control difference e1) between the target value of first physical quantity Sv1(s) and the control quantity Pv1(s) to the control portion 132-1 (e1(s)−Sv1(s)−Pv1(s)). The control portion 132-1 receives the input of the difference of the target value of first physical quantity Sv1(s) and the control quantity Pv1(s) to output the operation quantity Mv1(s) based on this difference. The control portion 132-1 is a controller to perform a PID control, for example.

Here, as using a transfer function G1(s) of the feedback control due to the first physical quantity (the control portion 132-1 of the first control portion 130-1), a relation between the target value of first physical quantity Sv1(s) together with the control quantity Pv1(s) and the operation quantity Mv1(s) output from the first control portion 130-1 is indicated as the following equation.

$$[ Math 1 ]$$

$$Mv 1 ( s ) = G 1 ( s ) \cdot ( Sv 1 ( s ) - Pv 1 ( s ) ) \qquad ( 1 )$$

The second control portion 130-2 receives the input of the target value of second physical quantity Sv2(s) and the control quantity Pv2(s) to output the operation quantity Mv2(s) of the control object 200. As shown in FIG. 2, the second control portion 130-2 includes a comparison portion 131-2 and a control portion 132-2. The comparison portion 131-2 receives the input of the target value of second physical quantity Sv2(s) and the control quantity Pv2(s) to output a difference (control difference e2) between the target value of second physical quantity Sv2(s) and the control quantity Pv2(s) to the control portion 132-2 (e2(s)−Sv2(s)−Pv2(s)). The control portion 132-2 receives the input of the difference of the target value of second physical quantity Sv2(s) and the control quantity Pv2(s) to output the operation quantity Mv2(s) based on this difference. The control portion 132-2 is a controller to perform a PID control, for example.

Here, as using a transfer function G2(s) of the feedback control due to the second physical quantity (the control portion 132-2 of the second control portion 130-2), a relation between the target value of second physical quantity Sv2(s) together with the control quantity Pv2(s) and the operation quantity Mv2(s) output from the second control portion 130-2 is indicated as the following equation.

$$[ Math 2 ]$$

$$Mv 2 ( s ) = G 2 ( s ) \cdot ( Sv 2 ( s ) - Pv 2 ( s ) ) \qquad ( 2 )$$

The switching portion 140 switches between two states including a state (first state) of outputting the operation quantity Mv1(s) output from the first control portion 130-1 to the control object 200, and a state (second state) of outputting the operation quantity Mv2(s) output from the second control portion 130-2 to the control object 200. According to the present embodiment, when the control mode of the control device 100 is the first mode, the state of the switching portion 140 is the first state, and when the control mode of the control device 100 is the second mode, the state of the switching portion 140 is the second state.

The switching control portion 150 switches the states of the switching portion 140 based on the control mode of the control device 100. For example, when the control mode of the control device 100 is the first mode (that is, the switching portion 140 is in the first state), if the input portion 110 receives an instruction input for switching from the first mode to the second mode, the switching control portion 150 switches the state of the switching portion 140 from the first state to the second state. Also, when the control mode of the control device 100 is the second mode (that is, the switching portion 140 is in the second state), if the input portion 110 receives an instruction input for switching from the second mode to the first mode, the switching control portion 150 may switch the state of the switching portion 140 from the second state to the first state.

Accordingly, in the present embodiment, it is possible to perform the feedback control with respect to the control object by two types of physical quantities including the first physical quantity and the second physical quantity. In particular, according to the present embodiment, it is possible to switch the physical quantity (control quantity) used in the feedback control when the control object is in operation.

There is a case in which it is difficult to stabilize the control system according to the feedback control due to the load (load control), and it is easy to stabilize the control system according to the feedback control due to the displacement (displacement control). According to the present embodiment, in such a case, it is possible to perform the displacement control at first for stabilizing the control system and subsequently to perform the load control.

There is a case in which, at the time of switching the control mode of the control device 100, the operation quantity input to the operation object 200 discontinuously changes to cause a shock (impact) to the control object 200. For example, at the time when the control mode of the control device 100 is switched from the first mode to the second mode, the operation quantity input to the control object is switched from the operation quantity Mv1(s) output from the first control portion 130-1 to the operation quantity Mv2(s) output from the second control portion 130-2. At the time of this switching, in a case in which the operation quantity Mv1(s) output from the first control portion 130-1 and the operation quantity Mv2(s) output from the second control portion 130-2 are not the same value, the change of the operation quantity input to the control object 200 becomes discontinuous to cause a shock (impact) to the control object 200.

Accordingly, in the present embodiment, at the time of switching the physical quantity used for the control, the target value output portion 120 uses an inverse transfer function after the switching to calculate the target value of the physical quantity after the switching so as to prevent the operation quantity input to the control object 200 before and after the switching from changing discontinuously.

For example, at the time of switching from the first mode to the second mode (for example, the input portion 110 receives the instruction input for switching from the first mode to the second mode), the target value output portion 120 receives a value Mv1 of the operation quantity Mv1(s) output from the first control portion 130-1 and a value Pv2 of the control quantity Pv2(s) of the second physical quantity, calculates a value Sv2 of the target value Sv2(s) of the second physical quantity using a value G2⁻¹ of the inverse transfer function G2 (s)⁻¹ of the feedback control due to the second physical quantity at the time of switching and based on both the value Mv1 of the operation quantity Mv1(s) output from the first control portion 130-1 at the time of switching and the value Pv2 of the control quantity Pv2(s) of the second physical quantity at the time of switching, and outputs the calculated value Sv2 to the second control portion 130-2.

$$[ Math 3 ]$$

$$Sv 2 = \frac{Mv 1}{G 2} + Pv 2$$

In this manner, according to the present embodiment, the operation quantity of the physical quantity after the switching (second physical quantity) is calculated by using the inverse transfer function of the feedback control due to the physical quantity after the switching (second physical quantity) so as to make the operation quantity of the physical quantity after the switching (second physical quantity) to be the same value with that of the operation quantity of the physical quantity before the switching (first physical quantity). As a result, according to the present embodiment, before and after the switching, there is not any discontinuous change in the operation quantity input to the control object 200, and it is possible to prevent any shock (impact) from being applied to the control object at the time of switching the physical quantity used in the feedback control.

Also, for example, at the time of switching from the second mode to the first mode (for example, the input portion 110 receives the instruction input for switching from the second mode to the first mode), the target value output portion 120 may receive a value Mv2 of the operation quantity Mv2(s) output from the second control portion 130-2 and a value Pv1 of the control quantity Pv1(s) of the first physical quantity, calculate a value Sv1 of the target value Sv1(s) of the first physical quantity using a value G1⁻¹ of the inverse transfer function G1(s)⁻¹ of the feedback control due to the first physical quantity at the time of switching and based on both the value Mv2 of the operation quantity Mv2(s) output from the second control portion 130-2 at the time of switching and the value Pv1 of the control quantity Pv1(s) of the first physical quantity at the time of switching, and output the calculated value Sv1 to the second control portion 130-2.

$$[ Math 4 ]$$

$$Sv 1 = \frac{Mv 2}{G 1} + Pv 1$$

<Control of vibrator> For example, in a case in which the control object 200 is the vibrator, the target value Sv1(s), the operation quantity Mv1(s), and the control quantity Pv1(s) of the first physical quantity are the same with the target value Sv2(s), the operation quantity Mv2(s), and the control quantity Pv2(s) of the second physical quantity as a sine wave with the same angular frequency ω. Currently, according to Math 1, it is possible to express the target value Sv2(s) of the second physical quantity in a phasor as shown below.

$$[ Math 5 ]$$

$$Sv 2 ( s ) = \frac{\vert Mv 1 ( s ) \vert}{\vert G 2 ( s ) \vert} \cdot {e}^{j \cdot ( arg ( Mv 1 ( s ) ) - arg ( G 2 ( s ) ) )} + \vert Pv 2 ( s ) \vert \cdot {e}^{j \cdot arg ( Pv 2 ( s ) )}$$

According to the equation shown above, the amplitude and the phase of the target value Sv2(s) of the second physical quantity are calculated. Similarly, according to Math 2, it is possible to express the target value Sv1(s) of the first physical quantity in a phasor as shown below.

$$Sv 1 ( s ) = \frac{\vert Mv 2 ( s ) \vert}{\vert G 1 ( s ) \vert} \cdot {e}^{j \cdot ( arg ( Mv 2 ( s ) ) - arg ( G 1 ( s ) ) )} + \vert Pv 1 ( s ) \vert \cdot {e}^{j \cdot arg ( Pv 1 ( s ) )}$$

According to the equation shown above, the amplitude and the phase of the target value Sv1(s) of the first physical quantity are calculated.

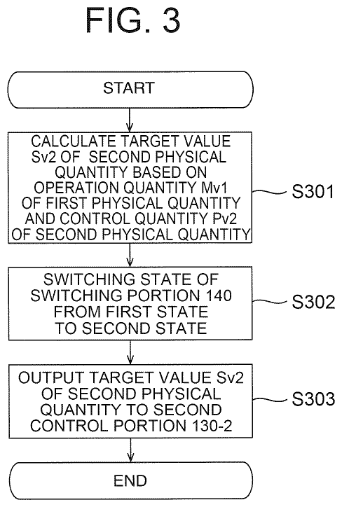

At this time, the target value output portion 120 may include the vibrator. Then, at the time of switching the physical quantity used in the feedback control, the target value output portion 120 may set the amplitude and the phase of the target value of the physical quantity after the switching which are calculated based on the equations shown above to the vibrator and cause this vibrator to output the signals of the target value of the physical quantity after the switching.

<Processing operations in control device 100> FIG. 3 is a view showing an example of the processing operations in the control device 100. The processing operations in FIG. 3 are executed in the control device 100 at the time of switching the control mode of the control device 100 from the first mode to the second mode (for example, at the time when the input portion receives the instruction input for switching from the first mode to the second mode).

The target value output portion 120 calculates the value Sv2 of the target value Sv2(s) of the second physical quantity using the value G2⁻¹ of the inverse transfer function G2 (s)⁻¹ of the feedback control due to the second physical quantity and based on the value Mv1 of the operation quantity Mv1(s) of the first physical quantity output from the first control portion 130-1 and the value Pv2 of the control value Pv2(s) of the second physical quantity (Step S301).

The switching control portion 150 switches the state of the switching portion 140 from the state (first state) of outputting the operation quantity Mv1(s) that is output from the first control portion 130-1 to the control object 200, to the state (second state) of outputting the operation quantity Mv2(s) that is output from the second control portion 130-2 to the control object 200 (Step S302).

The target value output portion 120 outputs the value Sv2 of the target value Sv2(s) of the second physical quantity that is calculated in Step S301 to the second control portion 130-2 (Step S303).

<Feedback control due to three or more types of physical quantities> As described above, the control device 100 is performing the feedback control with respect to the control object due to two types of physical quantities (first physical quantity and second physical quantity), however, it may be configured to perform the feedback control with respect to the control object due to N types (N is natural number equal to or more than 3) of physical quantities (first physical quantity, second physical quantity, . . . , Nth physical quantity).

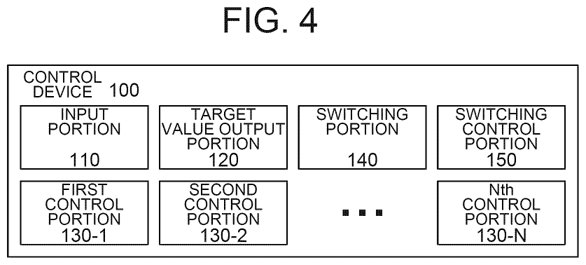

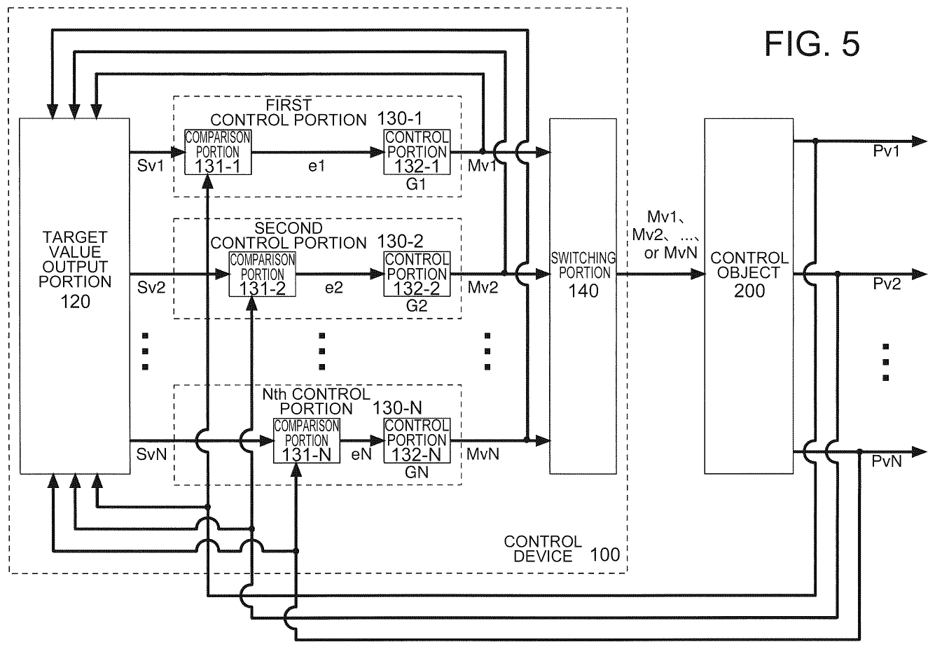

At this time, as shown in FIG. 4 and FIG. 5, the control device 100 includes N control portions 130 (first control portion 130-1, second control portion 130-2, . . . , Nth control portion 130-N). Then, the target value output portion 120 outputs the target value Sv1(s) of the first physical quantity, the target value Sv2(s) of the second physical quantity, . . . , and the target value SvN(s) of the Nth physical quantity, and the nth control portion 130-n (n=1, 2, . . . , N) receives the input of the target value Svn(s) of the nth physical quantity and the control quantity Pvn(s) to output the operation quantity Mvn(s) of the control object 200.

As shown in FIG. 5, the nth control portion 130-n includes the comparison portion 131-n and the control portion 132-n, wherein the comparison portion 131-n receives the input of the target value Svn(s) of the nth physical quantity and the control quantity Pvn(s), and outputs the difference (control difference en) between the target value Svn(s) of the nth physical quantity and the control quantity Pvn(s) to the control portion 132-n (en(s)=Svn(s)−Pvn(s)), and wherein the control portion 132-n receives the input of the difference between the target value Svn(s) and the control quantity Pvn(s) and outputs the operation quantity Mvn(s) based on this difference.

Here, if using the transfer function Gn(s) of the feedback control due to the nth physical quantity (control portion 132-n of the nth control portion 130-n), the relationship between the target value Svn(s) together with the control quantity Pvn(s) of the nth physical quantity and the operation quantity Mvn(s) output from the nth control portion 130-n is shown as the following equation.

$$[ Math 6 ]$$

$$Mvn ( s ) = Gn ( s ) \cdot ( Svn ( s ) - Pvn ( s ) )$$

Then, the switching portion 140 switches among the N states including the state (first state) of outputting the operation quantity Mv1(s) output from the first control portion 130-1 to the control object 200, the state (second state) of outputting the operation quantity Mv2(s) output from the second control portion 130-2 to the control object 200, . . . , and the state (Nth state) of outputting the operation quantity MvN(s) output from the Nth control portion 130-N to the control object 200. Then, the control modes of the control device 100 includes the first mode of performing the feedback control with respect to the control object 200 due to the first physical quantity, the second mode of performing the feedback control with respect to the control object 200 due to the second physical quantity, . . . , and the Nth mode of performing the feedback control with respect to the control object 200 due to the Nth physical quantity.

For example, when the control mode of the control device 100 is the nth (n=1, 2, . . . , N) (that is, the switching portion 140 is in the nth state), if the input portion 110 receives the instruction input for switching from the nth mode to the mth mode (m=1, 2, . . . , N, m is not equal to n), the switching control portion 150 switches the state of the switching portion 140 from the nth state to the mth state.

Hereinbefore, the present invention has been described using preferred embodiments of the present invention. Although the present invention has been described herein with reference to specific examples, various modifications and changes can be made to these examples without departing from the spirit and scope of the invention as set forth in the claims.

### REFERENCE SIGNS LIST

100 control device
110 input portion
120 target value output portion
130-1 first control portion
131-1 comparison portion of first control portion 130-1
132-1 control portion of first control portion 130-1
130-2 second control portion
131-2 comparison portion of second control portion 130-2
132-2 control portion of second control portion 130-2
130-N Nth control portion
131-N comparison portion of Nth control portion 130-N
132-N control portion of Nth control portion 130-N
140 switching portion
150 switching control portion
200 control object

What is claimed is:

1. An information processing method executed by a computer for performing a feedback control to a control object by various types of physical quantities, comprising:
when switching the physical quantities used in the feedback control, calculating a target value of the physical quantity after the switching by using an inverse transfer function after the switching.

2. The information processing method according to claim 1, wherein when switching the physical quantity used in the feedback control from a first physical quantity to a second physical quantity, calculating a target value of the second physical quantity based on both of an operation quantity in response to a difference between a target value of the first physical quantity and a control quantity, and a control quantity of the second physical quantity.

3. The information processing method according to claim 2, wherein when switching the physical quantity used in the feedback control from the second physical quantity to the first physical quantity, calculating a target value of the first physical quantity based on both of an operation quantity in response to a difference between a target value of the second physical quantity and a control quantity, and a control quantity of the first physical quantity.

4. An information processing device calculating target values of various types of physical quantities for performing a feedback control to a control object by various types of physical quantities, wherein when switching the physical quantities used in the feedback control, the information processing device calculates a target value of the physical quantity after the switching by using an inverse transfer function after the switching.

5. The information processing device according to claim 4, wherein when switching the physical quantity used in the feedback control from a first physical quantity to a second physical quantity, the information processing device calculates a target value of the second physical quantity based on both of an operation quantity in response to a difference between a target value of the first physical quantity and a control quantity, and a control quantity of the second physical quantity.

6. The information processing device according to claim 5, wherein when switching the physical quantity used in the feedback control from the second physical quantity to the first physical quantity, the information processing device calculates a target value of the first physical quantity based on both of an operation quantity in response to a difference between a target value of the second physical quantity and a control quantity, and a control quantity of the first physical quantity.

7. A control device performing the feedback control to the control object, comprising:
the information processing device according to claim 5;
a first control portion;
a second control portion; and
a switching portion,
wherein the information processing device outputs the target value of the first physical quantity and the target value of the second physical quantity,
the first control portion receives an input of the target value of the first physical quantity and the control quantity and outputs the operation quantity in response to the difference between the input target value of the first physical quantity and the control quantity,
the second control portion receives an input of the target value of the second physical quantity and the control quantity and outputs the operation quantity in response to the difference between the input target value of the second physical quantity and the control quantity, and
the switching portion
switches between a first state to input the operation quantity output from the first control portion to the control object and a second state to input the operation quantity output from the second control portion to the control object,
wherein it is the first state if the physical quantity used for the feedback control is the first physical quantity, and
it is the second state if the physical quantity used for the feedback control is the second physical quantity.

8. A control device performing the feedback control to the control object, comprising:
the information processing device according to claim 6;
a first control portion;
a second control portion; and
a switching portion,
wherein the information processing device outputs the target value of the first physical quantity and the target value of the second physical quantity,
the first control portion receives an input of the target value of the first physical quantity and the control quantity and outputs the operation quantity in response to the difference between the input target value of the first physical quantity and the control quantity,
the second control portion receives an input of the target value of the second physical quantity and the control quantity and outputs the operation quantity in response to the difference between the input target value of the second physical quantity and the control quantity, and
the switching portion,
switches between a first state to input the operation quantity output from the first control portion to the control object and a second state to input the operation quantity output from the second control portion to the control object,
wherein it is the first state if the physical quantity used for the feedback control is the first physical quantity, and
it is the second state if the physical quantity used for the feedback control is the second physical quantity.
